(19) United States
(12) Patent Application Publication
(10) Pub. No.: US 2014/0341179 A1
(43) Pub. Date: Nov. 20, 2014

(54) BASE STATION DEVICE, WIRELESS COMMUNICATION SYSTEM, WIRELESS COMMUNICATION DEVICE, FREQUENCY BAND ALLOCATION METHOD, AND PROGRAM

(71) Applicant: Sharp Kabushiki Kaisha, Osaka-shi, Osaka (JP)

(72) Inventors: Kazunari Yokomakura, Osaka-shi (JP); Hiroki Takahashi, Osaka-shi (JP); Jungo Goto, Osaka-shi (JP); Osamu Nakamura, Osaka-shi (JP); Yasuhiro Hamaguchi, Osaka-shi (JP)

(21) Appl. No.: 14/362,631

(22) PCT Filed: Dec. 5, 2012
(86) PCT No.: PCT/JP2012/081448

§ 371 Date: Jun. 4, 2014

(30) Foreign Application Priority Data
Dec. 5, 2011 (JP) 2011-266001

(51) Int. Cl. H04W 72/04

(52) U.S. Cl. CPC H04W 72/0453; H04W 72/0446
USPC 370/330; 370/329

(57) ABSTRACT

The present invention makes it possible to minimize a decrease in the efficiency of frequency band utilization even if a constraint is placed on the number of points when performing an orthogonal transform. A base station device includes an allocation determination unit configured to allocate a frequency band of subcarriers to each of a plurality of communication devices that applies an orthogonal transform to a signal to be transmitted and transmits the signal by arranging the signal on the subcarriers, a communication device selection unit configured to select, from among the plurality of communication devices, a communication device for which the number of subcarriers included in the frequency band allocated to the communication device by the allocation determination unit is not a prescribed number, and a frequency band adjustment unit configured to perform a change that changes a frequency band allocated to the selected communication device, from the frequency band allocated by the allocation determination unit. The frequency band adjustment unit performs the change in such a way that the number of subcarriers included in a frequency band obtained as a result of the change becomes the prescribed number.

### TECHNICAL FIELD

The present invention relates to a base station device, a wireless communication system, a wireless communication device, a frequency band allocation method, and a program.

### BACKGROUND ART

Standardization of the Long Term Evolution (LTE) system, which is a wireless communication system for the 3.9G mobile phones, is now complete, and recently, LET-A (LTE-Advanced) as a more advanced version of the LTE system is being standardized as one of the 4G wireless communication systems (also referred to as IMT-A, for example).

Two access schemes, Single Carrier Frequency Division Multiple Access (SC-FDMA) and Clustered DFT Spread Orthogonal Frequency Division Multiple Access (Clustered DFT-S-OFDMA), are adopted for the uplink (the line from the mobile station to the base station) of these systems. SC-FDMA, which is also called, for example, DFT-S-OFDM, is a scheme that performs a time-frequency transform of time signals into frequency signals by a discrete Fourier transform (DFT), and arranges the obtained frequency signals contiguously at arbitrary frequencies within the system bandwidth. In Clustered DFT-S-OFDMA, each frequency signal obtained in the same manner as in SC-FDMA is divided into multiple partial spectra called clusters, which can be arranged at arbitrary frequencies within the system bandwidth in a non-contiguous manner. While the maximum number of clusters is two in LTE-A, the number of clusters can be set to an arbitrary number.

In LTE and LTE-A, in order to reduce the amount of computation of the DFT, a limit is placed on the number of DFT points used in a butterfly computation on the basis of the concept of fast Fourier transform (FFT). Specifically, the number of DFT points that can be used by each mobile station device is limited to a number that is an integer multiple of the number of subcarriers included in a recourse block and satisfies Formula (1) (Non Patent Literature 1)

[Formula 1]

N_{sc}=2^{α}·3^{β}·5^{γ} (1)

In Formula (1), Nsc is the number of DFT points (which is the same as the bandwidth and thus can be also said to be the number of subcarriers or the number of discrete frequency points), and α, β, and γ each represent an integer not less than zero. Formula (1) indicates that the numbers of DFT points constituting the butterfly computation for implementing the DFT may be only 2, 3, and 5. As a result, the amount of computation and the circuit scale related to a transmit process can be reduced.

### CITATION LIST

### Non Patent Literature

NPL 1: 3GPP, “Evolved Universal Terrestrial Radio Access (E-UTRA); Physical channels and modulation”, TS36.211 v10.2.0

### SUMMARY OF INVENTION

### Technical Problem

However, NPL 1 mentioned above has the following problem. That is, owing to a constraint placed on the frequency bandwidth allocated to each mobile device as a result of the constrained number of DFT points, the efficiency of frequency bandwidth utilization may decrease in some cases. For example, even if seven resource blocks (RBs; one RB is made up of 12 subcarriers in NPL 1) exist as an unallocated frequency band, because of the requirement that Formula (1) be satisfied, the frequency band that can be actually allocated to a given mobile device is 6 RBs, resulting in lower efficiency of frequency band utilization.

The present invention has been made in view of the above circumstances, and accordingly it is an object of the present invention to provide a base station device, a wireless communication system, a wireless communication device, a frequency allocation method, and a program which make it possible to minimize a decrease in the efficiency of frequency band utilization, even if a constraint is placed on the number of points when performing an orthogonal transform.

### Solution to Problem

(1) The present invention has been made to address the above-mentioned problems. An aspect of the present invention relates to a base station device including an allocation determination unit configured to allocate a frequency band of subcarriers to each of a plurality of communication devices that applies an orthogonal transform to a signal to be transmitted and transmits the signal by arranging the signal on the subcarriers, a communication device selection unit configured to select, from among the plurality of communication devices, a communication device for which the number of subcarriers included in the frequency band allocated to the communication device by the allocation determination unit is not a prescribed number, and a frequency band adjustment unit configured to perform a change that changes a frequency band allocated to the selected communication device, from the frequency band allocated by the allocation determination unit. The frequency band adjustment unit performs the change in such a way that the number of subcarriers included in a frequency band obtained as a result of the change becomes the prescribed number.

(2) According to another aspect of the present invention, in the base station device mentioned above, the allocation determination unit allocates the frequency band in such a way that there is no overlap of allocated frequency bands between the plurality of communication devices, and the frequency band adjustment unit performs the change by permitting an overlap of allocated frequency bands between the selected communication device and another communication device, and performing an addition of a frequency band to the frequency band allocated by the allocation determination unit.

(3) According to another aspect of the present invention, in the base station device mentioned above, in a case of performing the addition of a frequency band, the frequency band adjustment unit performs the addition in order from a frequency band with high priority, among frequency bands that can be allocated.

(4) According to another aspect of the present invention, in the base station device mentioned above, the frequency band to be added by the frequency band adjustment unit is a frequency band that is adjacent to the frequency band allocated by the allocation determination unit.

(5) According to another aspect of the present invention, the base station device mentioned above includes a receiver configured to receive signals transmitted by the plurality of communication devices, and a signal detector configured to detect a signal of each of the communication devices from the received signals, and for a signal of the communication device for which the allocated frequency band overlaps another communication device, the signal detector performs interference cancellation to separate the signal from the received signals.

(6) According to another aspect of the present invention, in the base station device mentioned above, the interference cancellation is a non-linear iterative equalization based on a turbo principle or serial interference cancellation.

(7) According to another aspect of the present invention, in the base station device mentioned above, the orthogonal transform is a time-frequency transform.

(8) Another aspect of the present invention relates to a wireless communication system including a plurality of communication devices, and a base station. Each of the communication devices includes a transmitter. The transmitter is configured to apply an orthogonal transform to a signal to be transmitted and transmit the signal by arranging the signal on subcarriers. The base station device includes an allocation determination unit. The allocation determination unit is configured to allocate a frequency band of the subcarriers to each of the communication devices. The base station device or each of the communication devices includes a frequency band adjustment unit. The frequency band adjustment unit is configured to perform a change that changes the frequency band allocated by the allocation determination unit in a case where the number of subcarriers included in the frequency band allocated by the allocation determination unit is a prescribed number. The frequency band adjusting unit performs the change in such a way that the number of sub-carriers included in a frequency band obtained as a result of the change does not become the prescribed number.

(9) Another aspect of the present invention relates to a wireless communication device which applies an orthogonal transform to a signal to be transmitted, and transmits the signal to which the orthogonal transform has been applied by arranging the signal on subcarriers of a frequency band allocated by a base station device, the wireless communication device including a frequency band adjustment unit configured to perform a change that changes the frequency band allocated by the base station device in a case where the number of subcarriers included in the frequency band allocated by the base station device is a prescribed number. The frequency band adjustment unit performs the change in such a way that the number of subcarriers included in a frequency band obtained as a result of the change does not become the prescribed number.

(10) Another aspect of the present invention relates to a frequency band allocation method for a base station device, including a first step of allocating a frequency band of subcarriers to each of a plurality of communication devices that applies an orthogonal transform to a signal to be transmitted and transmits the signal by arranging the signal on the subcarriers, a second step of selecting, from among the plurality of communication devices, a communication device for which the number of subcarriers included in the frequency band allocated to the communication device in the first step is not a prescribed number, and a third step of performing a change that changes a frequency band allocated to the selected communication device, from the frequency band allocated by the first step. The third step includes performing the change in such a way that the number of subcarriers included in a frequency band obtained as a result of the change becomes the prescribed number.

(11) Another aspect of the present invention relates to a frequency band allocation method for a wireless communication device, the wireless communication device being configured to apply an orthogonal transform to a signal to be transmitted and transmit the signal to which the orthogonal transform has been applied by arranging the signal on subcarriers of a frequency band allocated by a base station device, the frequency band allocation method including a first step of performing a change that changes the frequency band allocated by the base station device in a case where the number of subcarriers included in the frequency band allocated by the base station device is a prescribed number. The first step includes performing the change in such a way that the number of subcarriers included in a frequency band obtained as a result of the change does not become the prescribed number.

(12) Another aspect of the present invention relates to a program for causing a computer of a base station device to function as an allocation determination unit configured to allocate a frequency band of subcarriers to each of a plurality of communication devices that applies an orthogonal transform to a signal to be transmitted and transmits the signal by arranging the signal on the subcarriers, a communication device selection unit configured to select, from among the plurality of communication devices, a communication device for which the number of subcarriers included in the frequency band allocated to the communication device by the allocation determination unit is not a prescribed number, and a frequency band adjustment unit configured to perform a change that changes a frequency band allocated to the selected communication device, from the frequency band allocated by the allocation determination unit. The frequency band adjustment unit performs the change in such a way that the number of subcarriers included in a frequency band obtained as a result of the change becomes the prescribed number.

(13) Another aspect of the present invention relates to a program for causing a computer of a wireless communication device to function as a frequency band adjustment unit, the wireless communication device being configured to apply an orthogonal transform to a signal to be transmitted and transmit the signal to which the orthogonal transform has been applied by arranging the signal on subcarriers of a frequency band allocated by a base station device, the frequency band adjustment unit being configured to perform a change that changes the frequency band allocated by the base station device in a case where the number of subcarriers included in the frequency band allocated by the base station device is a prescribed number. The frequency band adjustment unit performs the change in such a way that the number of subcarriers included in a frequency band obtained as a result of the change does not become the prescribed number.

### Advantageous Effects of Invention

According to the present invention, even if a constraint is placed on the number of points when performing an orthogonal transform, a decrease in the efficiency of frequency band utilization can be minimized.

### BRIEF DESCRIPTION OF DRAWINGS

FIG. 1 is a schematic block diagram illustrating a configuration of a wireless communication system according to a first embodiment of the present invention.

FIG. 2 is a schematic block diagram illustrating a configuration of a mobile station device 110 according to the first embodiment.

FIG. 3 is a schematic block diagram illustrating a configuration of a base station device 120 according to the first embodiment.

FIG. 4 is a schematic block diagram illustrating a configuration of a scheduler 27 according to the first embodiment.

FIG. 5 is a flowchart illustrating operation of the scheduler 27 according to the first embodiment.

FIG. 6 illustrates an example of the result of allocation by a resource determination unit 42 according to the first embodiment.

FIG. 7 illustrates an example of the result of allocation by the scheduler 27 according to the first embodiment.

FIG. 8 illustrates an example of the result of conventional allocation.

FIG. 9 illustrates an example of the result of allocation by the resource determination unit 42 according to a second embodiment of the present invention.

FIG. 10 illustrates an example of the result of allocation by the scheduler 27 according to the second embodiment.

FIG. 11 illustrates an example of the result of conventional allocation.

FIG. 12 illustrates an example of the result of allocation by the resource determination unit 42 according to a third embodiment of the present invention.

FIG. 13 illustrates an example of the result of allocation by the scheduler 27 according to the third embodiment.

FIG. 14 illustrates an example of the result of conventional allocation.

### DESCRIPTION OF EMBODIMENTS

### First Embodiment

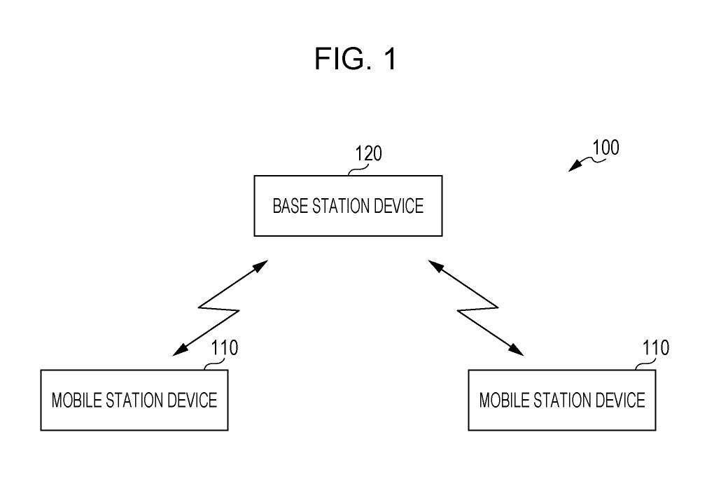

Hereinafter, a first embodiment of the present invention will be described with reference to the figures. FIG. 1 is a schematic block diagram illustrating a configuration of a wireless communication system 100 according to the first embodiment. As illustrated in FIG. 1, the wireless communication system 100 includes multiple mobile station devices 110 (hereinafter also referred to singularly as mobile station device 110 when there is no need to distinguish between individual mobile station devices 110) (communication devices), and a base station device 120 that communicates with the mobile station device 110. The base station device 120 allocates a subcarrier frequency band for use in uplink transmission to each of the mobile station devices 110. Each of the mobile station devices 110 transmits a signal by arranging the signal on subcarriers of the frequency band allocated by the base station device 120. The wireless communication system 100 according to the first embodiment uses Single Carrier Frequency Division Multiple Access (SC-FDMA) for the uplink. That is, the mobile station device 110 applies a time-frequency transform to the transmit signal by a DFT, and generates a frequency signal (also referred to as frequency domain signal). Then, the mobile station device 110 arranges the frequency domain signal on subcarriers of the frequency band allocated by the base station device 120, and transmits the resulting signal. While a DFT is used as a time-frequency transform in the first embodiment, a fast Fourier transform (FFT) may be used. Further, this transform may be any orthogonal transform in which there is a possibility of a limit being imposed on the number of points as in the case of the limit imposed on the number of points imposed by Formula (1) for the DFT. For example, a spread spectrum using a Walsh sequence (Hadamard transform) for which powers of 2 are generally used may be applied to this transform.

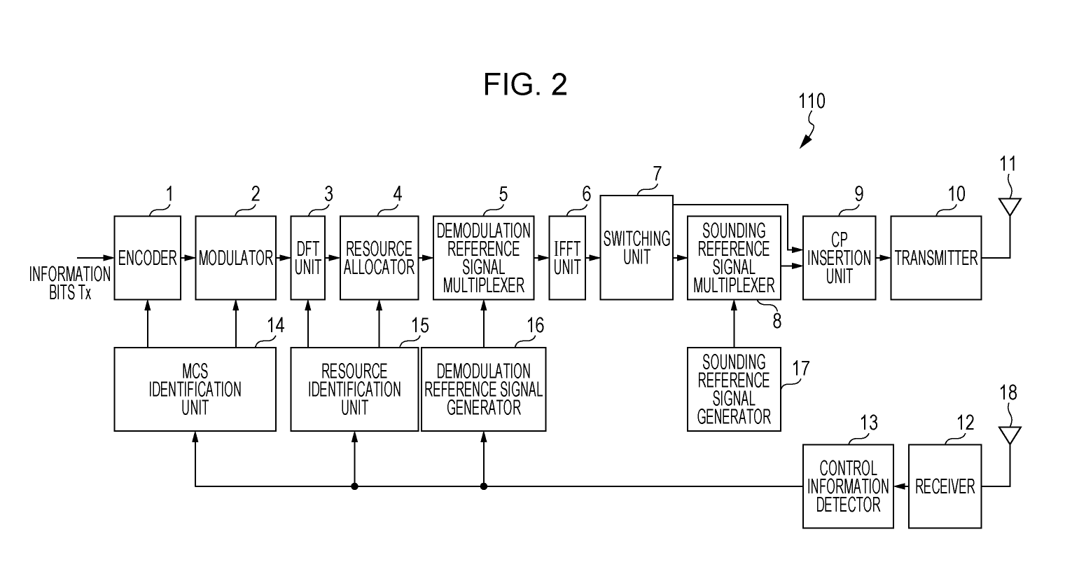

FIG. 2 is a schematic block diagram illustrating a configuration of the mobile station device 110. The mobile station device 110 includes an encoder 1, a modulator 2, a DFT unit 3, a resource allocator 4, a demodulation reference signal multiplexer 5, an IFFT unit 6, a switching unit 7, a sounding reference signal multiplexer 8, a CP insertion unit 9, a transmitter 10, a transmit antenna 11, a receiver 12, a control information detector 13, an MCS identification unit 14, a resource identification unit 15, a demodulation reference signal generator 16, a sounding reference signal generator 17, and a receive antenna 18.

The receive antenna 18 receives a signal transmitted by the base station device 120. The receiver 12 applies processing such as down-conversion and analog to digital (A/D) conversion to the signal received by the base station device 120, thereby generating digital data. The control signal detector 13 extracts control information from this digital data. In LTE and LTE-A, for example, this control information is a control bit that is transmitted on a control channel called Physical Downlink Control Channel (PDCCH), and used for a transmission control called Downlink Control Information (DCI) format. However, this control information may be any control information used for transmission control, and is not limited to control information in LTE or LTE-A. In LTE and LTE-A, the DCI format used for transmission control on the uplink is defined as DCI format0 or DCI format4, which is detected by the control signal detector 13. In this way, the control signal detector 13 detects a control bit used for transmission control on the uplink. The mobile station device 110 transmits transmit data in accordance with this control bit.

The control signal detector 13 notifies the MCS identification unit 14 of the transport block size (the number of information bits), the coding rate, and the modulation scheme indicated by the detected control bit. Further, the control signal detector 13 notifies the resource identification unit 15 of the number of DFT points and the resource index indicated by the detected control bit. In this regard, the number of DFT points is the number of modulation symbols when applying a DFT. A resource index is also called frequency band allocation information, and represents the frequency position (subcarrier) at which to arrange a frequency signal. In the first embodiment, a contiguous frequency band is allocated to each of the mobile station devices 110. Consequently, frequency band allocation information includes, for example, an index indicating the low frequency-side end of the frequency band being allocated, and an index indicating the bandwidth of the frequency band. In an alternative configuration that may be employed, control information does not include the number of DFT points, and the control signal detector 13 calculates the number of DFT points from a resource index included in the control information. For example, the number of subcarriers included in the frequency band indicated by a resource index serves as the number of DFT points. In addition, the control signal detector 13 notifies the demodulation signal reference signal generator 16 of the pattern of a demodulation reference signal (DMRS) indicated by the detected control bit. The pattern of a demodulation reference signal refers to, for example, information that specifies a code sequence to be used as the demodulation reference signal.

The MCS identification unit 14 notifies the encoder 1 of the transport block size and the coding rate notified from the control signal detector 13. Further, the MCS identification unit 14 notifies the modulator 2 of the modulation scheme notified from the control signal detector 13. The resource identification unit 15 notifies the DFT unit 3 of the number of DFT points notified from the control signal detector 13. Further, the resource identification unit 15 notifies the resource allocator 4 of the resource index notified from the control signal detector 13. The demodulation reference signal generator 16 generates a demodulation reference signal (DMRS) of the pattern notified from the control signal detector 13, and outputs the demodulation reference signal to the demodulation reference signal multiplexer 5.

The encoder 1 divides inputted information bits Tx into blocks of a number of bits indicated by the notified transport block size. The encoder 1 applies error-correction coding to the divided information bits Tx at the notified coding rate, thereby generating coded bits. The modulator 2 modulates each coded bit in accordance with the notified modulation scheme to generate a modulated signal modulated with quaternary phase shift keying (QPSK) or 16-ary quadrature amplitude modulation (16QAM). The DFT unit 3 applies a time-frequency transform to the modulated signal having the notified number of DFT points, thereby generating a frequency signal. This time-frequency transform is performed by a DFT. The number of DFT points in the DFT that can be executed by the DFT unit 3 is a number (prescribed number) including only 2, 3, and 5 as its prime factors. That is, the number of DFT points must equal Nsc that satisfies Formula (1).

The resource allocator 4 arranges each frequency signal at a frequency position specified by the notified resource index. The demodulation reference signal multiplexer 5 time-multiplexes DMRS on the signal obtained by arranging a frequency signal at each corresponding frequency position by the resource allocator 4. The frequency position at which DMRS is multiplexed is the same as the frequency position at which each frequency signal is arranged by the resource allocator 4. As for MMRS, MMRS may be multiplexed in such a way that MMRS is used when performing demodulation (signal detection) at the receiver, and the frequency position at which DMRS is multiplexed and its multiplexing method (such as time multiplexing or frequency multiplexing) are not limited to those of the above-mentioned example. The IFFT unit 6 applies an inverse fast Fourier transform (IFFT) to the signal on which DMRS is multiplexed, thereby generating a time signal (also referred to as time domain signal). This IFFT is performed with the number of FFT points (system bandwidth) defined by the wireless communication system 100.

The switching unit 7 determines whether or not the subframe in which to transmit the time domain signal generated by the IFFT unit 6 is a subframe in which to transmit a sounding reference signal (SRS). A subframe is the minimum unit in the time direction when allocating resources to the mobile station device 110, and is obtained by time-multiplexing a prescribed number of DFT blocks. A subframe is also referred to as frame or packet, for example. A SRS is a reference signal used in the base station device 120 for measuring (sounding) the channel condition. This channel condition is used when determining allocation of a frequency band to each of the mobile station devices 110 as will be described later. In a case where it is determined that the subframe in question is a subframe in which to transmit SRS, the switching unit 7 outputs the time domain signal generated by the IFFT unit 6 to the sounding reference signal multiplexer 8. In a case where it is determined that the subframe in question is not a subframe in which to transmit SRS, the switching unit 7 outputs the time domain signal to the CP insertion unit 9 without performing any processing.

The sounding reference signal generator 17 generates a SRS. The sounding reference signal multiplexer 8 time-multiplexes the time domain signal inputted from the switching unit 7 with the SRS, and outputs the resulting signal to the CP insertion unit 9. The CP insertion unit 9 performs CP insertion by inserting a cyclic prefix (CP) into the time domain signal inputted from the sounding reference signal multiplexer 8 or the switching unit 7. A CP is the last part of a time domain signal copied for a predefined length. The CP insertion unit 9 inserts this CP into the beginning of a time domain signal. The transmitter 10 applies transmit processing such as digital to analog (D/A) conversion, up-conversion, and amplification to the time domain signal into which the CP has been inserted, and transmits the resulting signal to the base station device 120 from the transmit antenna 11.

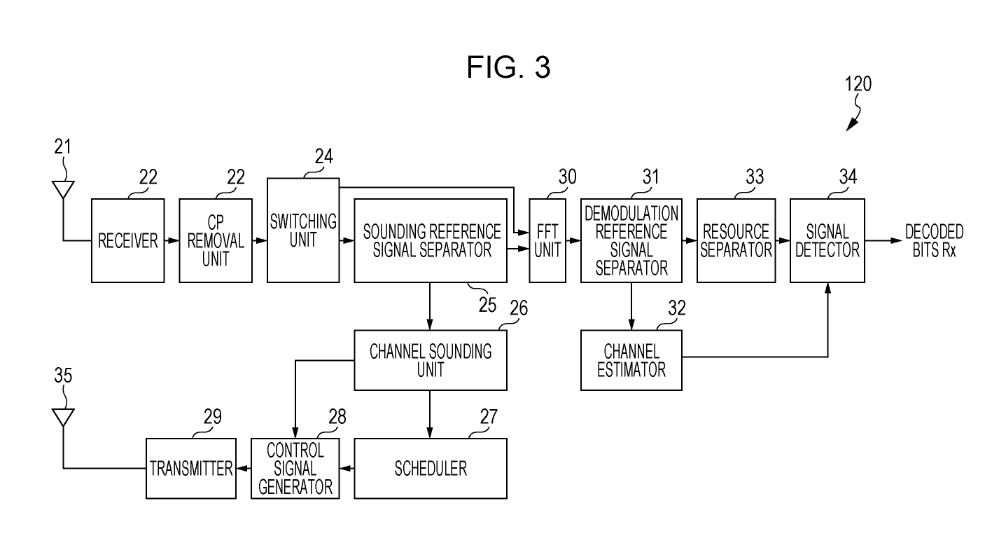

FIG. 3 is a schematic block diagram illustrating a configuration of the base station device 120. The base station device 120 includes a receive antenna 21, a receiver 22, a CP removal unit 23, a switching unit 24, a sounding reference signal separator 25, a channel sounding unit 26, a scheduler 27, a control signal generator 28, a transmitter 29, a FFT unit 30, a demodulation reference signal separator 31, a channel estimator 32, a resource separator 33, a signal detector 34, and a transmit antenna 35. As for the demodulation reference signal separator 31, the channel estimator 32, the resource separator 33, and the signal detector 34, the base station device 120 may include the same number of these units as the number of the mobile station devices 110 constituting the wireless communication system 100, and each of these units may detect a signal corresponding to one of the mobile station devices 110. Alternatively, the base station device 120 may include only one demodulation reference signal separator 31, one channel estimator 32, one resource separator 33, and one signal detector 34. In this case, each of these units operates iteratively the same number of times as the number of the mobile station devices 110, and detects a signal corresponding to one of the mobile station devices 110 at each iteration of the operation.

The receive antenna 21 receives a signal transmitted by the mobile station device 110. The receiver 22 applies receive processing such as down-conversion and A/D conversion to the signal received by the receive antenna 21, thereby obtaining a digital signal. The CP removal unit 23 removes the cyclic prefix (CP) from this digital signal. The switching unit 24 determines whether or not the subframe in which the CP-removed signal is included is a subframe on which a sounding reference signal (SRS) is multiplexed. At this time, in a case where it is determined that the subframe is not a subframe on which an SRS is multiplexed, the switching unit 24 outputs the CP-removed signal to the FFT unit 30 as it is. In a case where it is determined that the subframe is a subframe on which an SRS is multiplexed, the switching unit 24 outputs the CP-removed signal to the sounding reference signal separator 25 as it is. The sounding reference signal separator 25 separates the SRS from the CP-removed signal. The sounding reference signal separator 25 outputs the separated SRS to the channel sounding unit 26, and outputs the remainder of the signal to the FFT unit 30.

The channel sounding unit 26 calculates, from the SRS separated by the sounding reference signal separator 25, the condition of the channel at the frequency at which the SRS is arranged. Since the SRS is transmitted by each of the mobile station devices 110, the channel sounding unit 26 performs calculation of the channel condition for each of the mobile station devices 110. While calculation of the channel condition is performed in units of resource blocks (12 subcarriers) in the first embodiment, the calculation may be performed in other units of transmission control, for example, in units of its subcarriers. A channel condition refers to, for example, received signal to interference plus noise power ratio (SINR), or communication path capacity (transmission path capacity/channel capacity).

The scheduler 27 determines the frequency band to be allocated to each of the mobile station devices 110 and the number of DFT points on the basis of the channel condition calculated by the channel sounding unit 26. Further, in addition to frequency band allocation, the scheduler 27 also determines the coding rate and the modulation scheme for each of the mobile station devices 110. The scheduler 27 outputs these pieces of information thus determined to the control signal generator 28. The method of frequency allocation by the scheduler 27 will be descried later. On the basis of the information inputted from the scheduler 27, for each of the mobile station devices 110, the control signal generator 28 generates control information, and generates a control signal representing the control information. This control information includes a resource index indicating the result of frequency band allocation, information indicating the number of DFT points, information indicating the coding rate, and information indicating the modulation scheme. The transmitter 29 applies radio transmission processing such as up-conversion and D/A conversion to this control signal, and then transmits the resulting signal to each of the mobile station devices 110 from the transmit antenna 35.

The FFT unit 30 applies a time-frequency transform to a signal inputted from the switching unit 24 or the sounding reference signal separator 25 by a fast Fourier transform, thereby generating a frequency signal. The demodulation reference signal separator 31 separates a DMRS from this frequency signal. The demodulation reference signal separator 31 outputs the separated DMRS to the channel estimator 32, and outputs the remainder of the frequency signal to the resource separator 33. The channel estimator 32 estimates the channel characteristics of subcarriers (discrete frequencies) used for transmission by the individual mobile station devices 110, and the noise power including interferences from other cells, and outputs the obtained results to the signal detector 34.

The resource separator 33 detects only the signal of a frequency band that has been used by the mobile station device 110 to be detected (hereinafter, referred to as “target mobile station device 110”), from the frequency signal inputted from the demodulation reference signal separator 31. The frequency band that has been used by the mobile station device 110 is a frequency band allocated to the corresponding mobile station device 110 by the scheduler 27. Consequently, the resource separator 33 acquires this information from the scheduler 27. The signal detector 34 performs signal detection processing such as equalization, demodulation of modulated symbols, and error-correction decoding with respect to the signal extracted by the resource separator 33, thereby obtaining decoded bits Rx corresponding to information bits Tx inputted to the target mobile station device 110. As will be described later, frequency bands allocated to the mobile station devices 110 may overlap among the mobile station devices 110 in some cases. Consequently, signal detection by the signal detector 34 includes separating the signal of the target mobile station device 110 from the frequency signals of the overlapping frequency bands. This separation process may be implemented by interference cancellation provided by non-linear iterative equalization (turbo equalization) based on the turbo principle, or may be implemented by serial interference cancellation such as successive interference cancellation (SIC) that serially detects signals of the mobile station devices 110 by performing ranking.

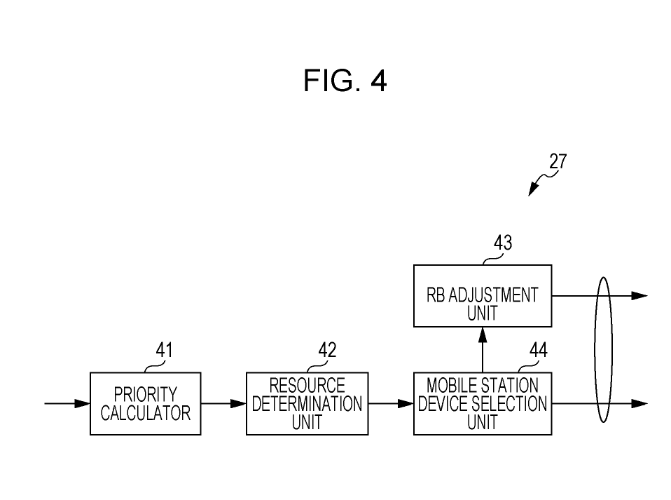

FIG. 4 is a schematic block diagram illustrating a configuration of the scheduler 27 according to the first embodiment. The scheduler 27 includes a priority calculator 41, a resource determination unit 42, a RB adjustment unit 43, and a mobile station device selection unit 44. The priority calculator 41 calculates the priority of each of the mobile station devices 110 in each resource block, on the basis of the channel condition in each resource block of each of the mobile station devices 110 inputted from the sounding unit 26. The priority calculator 41 performs this priority calculation by, for example, the Max CIR method in which the received SINR serves as the priority of each of the mobile station devices 110, or the proportional fairness (PF) method that calculates priority by Formula (2).

$$\begin{matrix}[ Formula 2 ] & \\ P ( u , m ) = \frac{R ( u , m )}{{R}_{ave} ( u )} & ( 2 )\end{matrix}$$

In Formula (2), P(u, m) denotes the priority of the m-th resource block of the u-th mobile station device 110. The greater this value, the higher the priority of this resource block. In addition, R(u, m) denotes estimated throughput in a case where it is assumed that the m-th resource block is allocated to the u-th mobile station device 110, and Rave(u) denotes the average throughput achieved until the timing of scheduling of the u-th mobile station device 110.

The resource determination unit 42 (allocation determination unit) allocates each resource block (frequency band) to the mobile station device 110 that has the highest priority in the corresponding resource block, on the basis of the priority calculated in this way. That is, the resource determination unit 42 allocates a frequency band to each of the mobile station devices 110. It should be noted, however, that the resource determination unit 42 performs this allocation in such a way as to satisfy Condition A and Condition B. Condition A requires that each of the mobile station devices 110 be allocated resource blocks that are contiguous in the frequency direction. Condition B requires that multiple mobile station devices 110 be not assigned to each resource block. Because Single Carrier Frequency Division Multiple Access is used for the uplink in the first embodiment, the allocation is performed in such a way that the allocation result satisfies Condition A. For example, the resource determination unit 42 performs this allocation by finding, in order from the mobile station device 110 with low average throughput, an allocation that satisfies Conditions A and B mentioned above and maximizes the sum of the priorities of the allocated resource blocks. The number of resource blocks to be allocated to each of the mobile station devices 110 may be, for example, a predetermined number, a number requested by each of the mobile station devices 110, or a number determined in accordance with the quality of service (QoS).

The result of allocation by the resource determination unit 42 is inputted to the mobile station device selection unit 44 (communication device selection unit 9. The mobile station device selection unit 44 determines, for each of the mobile station devices 110, whether or not the number of DFT points indicated by the allocation result satisfies Formula (1). That is, for each of the mobile station devices 110, the mobile station device selection unit 44 determines whether or not the number of DFT points (which is the same as the number of subcarriers) indicated by the allocation result is a number (prescribed number) that has only 2, 3, and 5 as its prime factors. For the mobile station device 110 whose number of DFT points is determined to satisfy Formula (1), the mobile station device selection unit 44 outputs the result of allocation by the resource determination unit 42 as it is as the final frequency band allocation result. For the mobile station device 110 whose number of DFT points is determined not to satisfy Formula (1) (the number of resource blocks that provides a number of DFT points not satisfying Formula (1) will be hereinafter referred to as “unallocatable resource block count”), the mobile station device selection unit 44 outputs the result of allocation by the resource determination unit 42 to the RB adjustment unit 43.

The RB adjustment unit 43 (frequency band adjustment unit) changes the allocation result inputted from the mobile station device selection unit 44 so as to satisfy Formula (1). More specifically, the RB adjustment unit 43 increases the number of resource blocks to be allocated. When increasing the number of allocated resource blocks in this way, the RB adjustment unit 43 permits an overlap of allocated resource blocks between the mobile station device 110 to which resource blocks are to be allocated, and another mobile station device 110. Then, the RB adjustment unit 43 outputs the increased number of resource blocks as the final frequency band allocation result.

Specifically, the RB adjustment unit 43 adds a resource block adjacent to either end of the group of resource blocks that have been allocated, until the allocation result satisfies Formula (1). As regards to which one of the two ends of the resource block group a resource block is to be added, for example, one with the higher priority may be selected, or one that is not allocated to another mobile station device 110 may be selected. While the above example is directed to the case where the number of resource blocks to be added is minimum, the number of RBs may be further increased for cases such as when it is determined that throughput will become higher as a result.

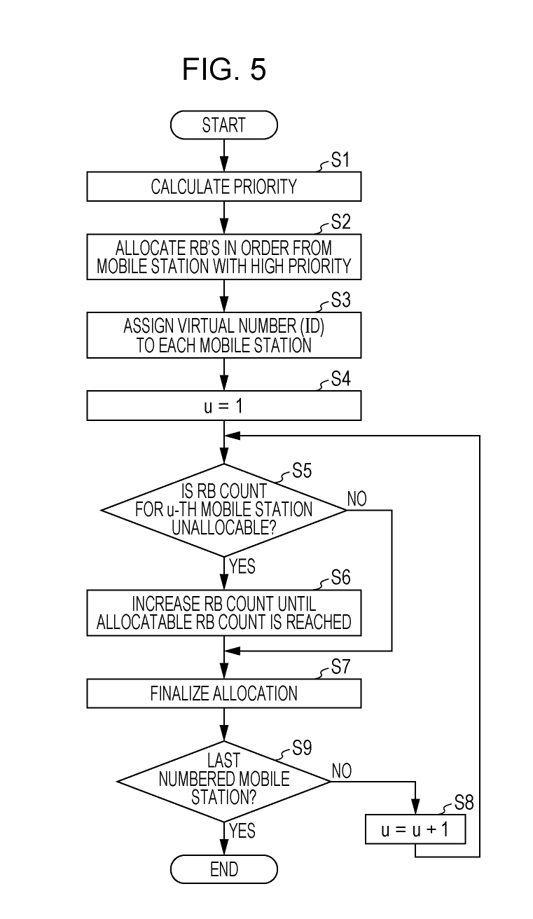

FIG. 5 is a flowchart illustrating operation of the scheduler 27 according to the first embodiment. First, in step S1, the priority calculator 41 calculates a priority for each individual combination of resource block (RB) and the mobile station device 110. Next, in step S2, the resource determination unit 42 allocates RBs individually to the mobile station devices 110 on the basis of the priority. Next, in step S3, the mobile station device selection unit 44 assigns a virtual serial number (which may be an ID) to each of the mobile station devices 110. Next, in step S4, the mobile station device selection unit 44 sets a serial number u, which indicates the mobile station device 110 to be processed, as u=1. Next, in step S5, the mobile station device selection unit 44 determines whether or not the allocation executed by step S2 for the mobile station device 110 having the number u results in an unallocatable RB count. In a case where it is determined that the allocation results in an unallocatable RB count (S5-Yes), the processing transitions to step S6. In step S6, the RB adjustment unit 43 increases the number of RBs until the allocation results in an allocatable RB count. Next, in step S7, the RB adjustment unit 43 finalizes the allocation. That is, the RB adjustment unit 43 accepts the result of allocation up to this point as the final result of frequency band allocation, and transitions to step S9. In a case where it is determined in step S5 that the allocation does not result in an unallocatable RB count (S5-No), the processing directly transitions to step S7 mentioned above.

In step S9, it is determined whether or not the u-th mobile station 110 is the last numbered mobile station device 110. In a case where it is determined that the u-th mobile station 110 is the last numbered mobile station device 110 (S9-Yes), the allocation is ended. In a case where it is determined that the u-th mobile station 110 is not the last numbered mobile station device 110 (S9-No), the processing transitions to step S8. In step S8, the mobile station device selection unit 44 adds 1 to the serial number u, and sets the serial u as the number of the mobile station device 110 for which allocation has not been finalized, and returns to step S5. In this way, by repeating processing from step S5 onward until the last numbered mobile station device 110 is reached, frequency band allocation is finalized for all of the mobile station devices 110.

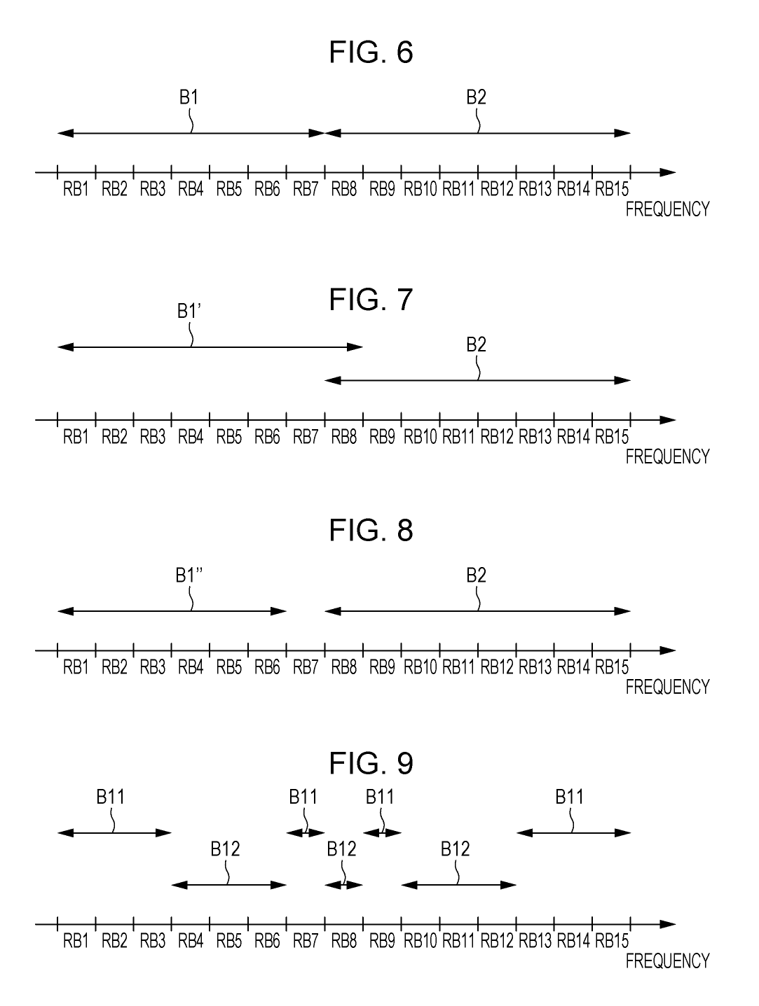

FIG. 6 illustrates an example of the result of allocation by the resource determination unit 42. In FIG. 6, the horizontal axis represents frequency. Further, symbols RB1, RB2, . . . and RB15 each denote a resource block. In the example illustrated in FIG. 6, the resource determination unit 42 allocates a frequency band (from resource blocks RB1 to RB7) denoted by symbol B1 to the first mobile station device 110, and allocates a frequency band (from resource blocks RB8 to RB15) denoted by symbol B2 to the second mobile station device 110. Because the frequency band B1 is made up of seven resource blocks, the corresponding number of DFT points is 7×12=84. The prime factors of 84 are 2, 3, and 7, and hence Formula (1) is not satisfied. Because the frequency band B2 is made up of eight resource blocks, the corresponding number of DFT points is 8×12=96. The prime factors of 96 are only 2 and 3, and hence Formula (1) is satisfied.

FIG. 7 illustrates an example of the result of allocation by the scheduler 27 according to the first embodiment. In FIG. 7, the horizontal axis represents frequency. The allocation result illustrated in FIG. 7 is an example of the result of allocation by the scheduler 27 when the allocation illustrated in FIG. 6 has been executed by the resource determination unit 42. Because the frequency band B1 illustrated in FIG. 6 does not satisfy Formula (1), the RB adjustment unit 43 adds a resource block RB8 to the frequency band B1, and determines the resulting frequency band B1′ as the result of allocation to the first mobile station device 110 by the scheduler 27. Because the frequency band B1′ is made up of eight resource blocks, the corresponding number of DFT points is 8×12=96, and hence Formula (1) is satisfied. At this time, since the frequency band B2 illustrated in FIG. 6 satisfies Formula (1), the mobile station device selection unit 44 determines the frequency band B2, which is obtained as a result of allocation by the resource determination unit 42, as the result of allocation to the second mobile station device 110 by the scheduler 27 as it is.

FIG. 8 illustrates an example of the result of conventional allocation. The example illustrated in FIG. 8 represents the result of conventional allocation executed in the same situation as when the resource determination unit 42 has performed allocation as illustrated in FIG. 6. In conventional methods such as NPL 1, in a case where SC-FDMA is used, allocation is performed so as to satisfy Formula (1), in addition to Conditions A and B mentioned above. Accordingly, while the second mobile station device is allocated the frequency band B2 as in illustrated in FIG. 7, the first mobile station device is allocated a frequency band B1″ that is obtained by removing the resource block B7 from the frequency band B1 and thus made up of resource blocks RB1 to RB6.

In this way, the first embodiment avoids the limitation on the number of RBs (the number of DFT points) by allocating the frequency band B1′ to the first mobile station device 110. Further, in the resource block RB8, non-orthogonal multiplexing (which may be also called non-orthogonal access in the sense that this concerns a method of sharing radio resources) is performed in which the frequency band allocated to the first mobile station device 110 and the frequency band allocated to the second mobile station device 110 overlap. Because this type of multiplexing can be considered to be orthogonal multiplexing if there are two or more receive antennas, such multiplexing may be called orthogonal multiplexing. However, intentionally causing a partial overlap of frequency bands to occur will be herein referred to as non-orthogonal multiplexing. In this way, orthogonal/non-orthogonal hybrid access, in which non-orthogonal access in the resource block RB8 and orthogonal access in resource blocks other than RB8 coexist, is used in order to avoid the limitation on the number of RBs. Therefore, it is also possible to increase the utilization of allocated resources relative to the resources in the entire system bandwidth.

In this way, in the first embodiment, resource blocks that should be allocated can be used by each of the mobile station devices 110 while avoiding an unallocatable resource block count. The efficiency of frequency utilization increases as a result. That is, even if a constraint is placed on the number of DFT points, a decrease in the efficiency of frequency band utilization can be minimized. Further, for example, as illustrated in FIG. 7, although the number of RBs for the system as a whole is 15, the number of RBs allocated to each of the first and second mobile station devices is eight, which is equivalent to using 16 RBs in total. This ability to allocate more radio resources for some resource blocks also contributes to higher utilization efficiency of radio resources.

In the first embodiment, the base station device 120 allocates a frequency band to the mobile station device 110. However, an alternative configuration is also possible in which the mobile station device 110 includes the RB adjustment unit 43, and in a case where the frequency band allocated by and notified from the base station device 120 results in an unallocatable resource block count, the RB adjustment unit 43 of the mobile station device 110 increases the number of resource blocks to be used so that the number of resource blocks to be used does not become an unallocatable resource block count. The determination as to which resource block to increase may be made by using reception quality in a case where reception quality can be known, or may be made on the basis of a predetermined rule. For example, a conceivable method would be to increase the number of resource blocks of high frequency components to the smallest number that is not an unallocatable resource block count and exceeds the number of resource blocks that have been allocated. However, any rule may be employed as long as the resource block(s) to be increased can be uniquely recognized. Further, at the base station device 120 that performs receive processing, signals from multiple base station devices 110 may be received in an overlapping manner. In this case, the base station device 120 receives a number of resource blocks different from the number of resource blocks that has been notified. Accordingly, it may be determined in advance to notify the index of each increased resource block from the mobile station device 110. Alternatively, it is also possible to employ a method in which signal processing is attempted multiple times for all of the candidates of increased resource blocks at the time of signal detection and the one with the best reception performance is determined as the detection result.

### Second Embodiment

Hereinafter, a second embodiment of the present invention will be described with reference to the figures. The second embodiment is directed to a case where Clustered DFT-S-OFDMA with no constraint on the number of divisions (the number of clusters) is used for the uplink. In this regard, the number of divisions refers to the number of divisions of the frequency band allocated to the mobile station device 110. In the first embodiment, the frequency band to be allocated is contiguous, and hence the number of divisions is zero. Clustered DFT-S-OFDMA is an example different from SC-FDMA which performs time-frequency transform of a transmit signal by DFT and transmits the resulting signal by arranging the signal on subcarriers.

Since the wireless communication system 100, the mobile station device 110, and the base station device 120 according to the second embodiment are configured in the same manner as in FIGS. 1, 2, 3, and 4, a description of their configuration will be omitted. However, the second embodiment differs from the first embodiment in the operation of the resource determination unit 42 of the base station device 120. In the first embodiment, when allocating a frequency band, the resource determination unit 42 is configured to satisfy Condition A requiring that the mobile station device 110 be allocated resource blocks that are contiguous in the frequency direction. However, since Clustered DFT-S-OFDMA is used for the uplink in the second embodiment, the resource determination unit 42 according to the second embodiment performs frequency band allocation without being constrained by Condition A mentioned above.

FIG. 9 illustrates an example of the result of allocation by the resource determination unit 42 according to the second embodiment. In FIG. 9, the horizontal axis represents frequency. Further, symbols RB1, RB2, . . . and RB15 each denote a resource block. In the example illustrated in FIG. 9, the resource determination unit 42 allocates a frequency band (resource blocks RB1 to RB3, RB7, RB9, and RB13 to RB15) denoted by symbol B11 to the first mobile station device 110. Further, the resource determination unit 42 allocates a frequency band (resource blocks RB4 to RB6, RB8, and RB10 to RB12) denoted by symbol B12 to the second mobile station device 110. Because the frequency band B11 is made up of eight resource blocks, the corresponding number of DFT points is 8×12=96. The prime factors of 96 are only 2 and 3, and hence Formula (1) is satisfied. Because the frequency band B12 is made up of seven resource blocks, the corresponding number of DFT points is 7×12=84. The prime factors of 84 are 2, 3, and 7, and hence Formula (1) is not satisfied.

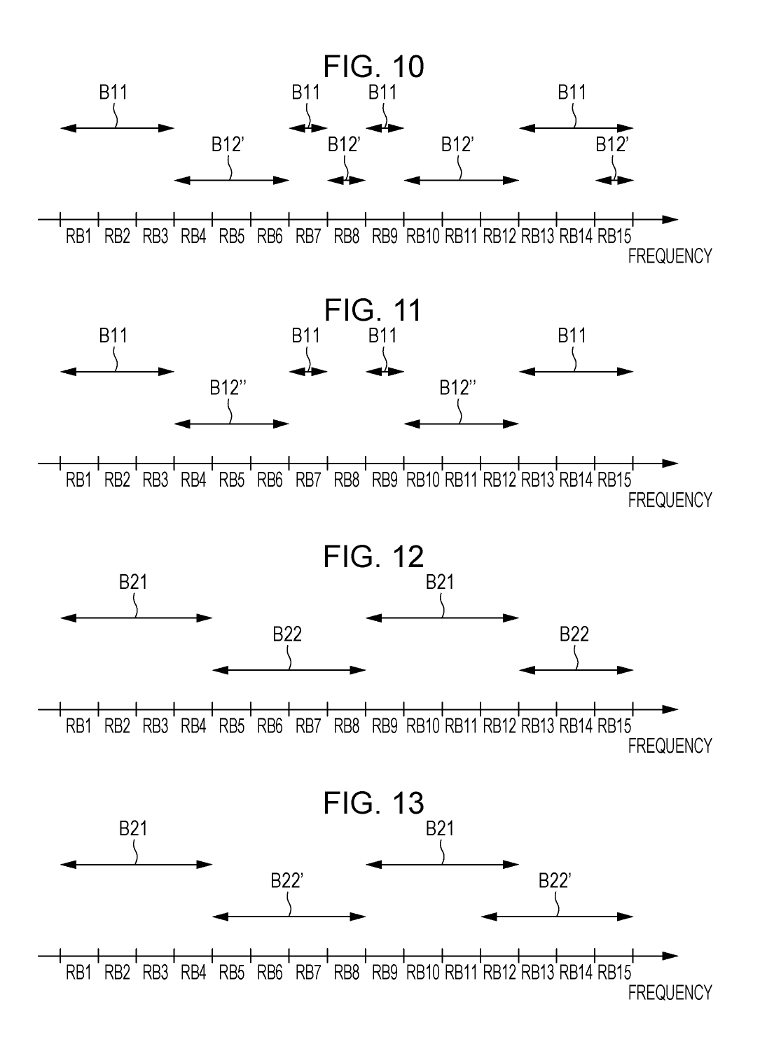

FIG. 10 illustrates an example of the result of allocation by the scheduler 27 according to the second embodiment. In FIG. 10, the horizontal axis represents frequency. The allocation result illustrated in FIG. 10 is an example of the result of allocation by the scheduler 27 when the allocation illustrated in FIG. 9 has been executed by the resource determination unit 42. Because the frequency band B12 illustrated in FIG. 9 does not satisfy Formula (1), the RB adjustment unit 43 adds a resource block RB15 to the frequency band B12, and determines the resulting frequency band B12′ as the result of allocation to the first mobile station device 110 by the scheduler 27. Because the frequency band B12′ is made up of eight resource blocks, the corresponding number of DFT points is 8×12=96, and hence Formula (1) is satisfied. At this time, since the frequency band B11 illustrated in FIG. 9 satisfies Formula (1), the mobile station device selection unit 44 determines the frequency band B11, which is obtained as a result of allocation by the resource determination unit 42, as the result of allocation to the second mobile station device 110 by the scheduler 27 as it is.

FIG. 11 illustrates an example of the result of conventional allocation. The example illustrated in FIG. 11 represents the result of conventional allocation executed in the same situation as when the resource determination unit 42 has performed allocation as illustrated in FIG. 9. In conventional methods such as NPL 1, in a case where Clustered DFT-S-OFDM with no constraint on the number of divisions is used, allocation is performed so as to satisfy Formula (1), in addition to Conditions A and B mentioned above. Accordingly, while the first mobile station device is allocated the frequency band B11 as in FIG. 10, the second mobile station device is allocated a frequency band B12″ that is obtained by removing the resource block RB8 from the frequency band B12 and thus made up of resource blocks RB4 to RB6, and RB10 to RB12.

In this way, also in a case where Clustered DFT-S-OFDM is used for the uplink, resource blocks that should be allocated can be used by each of the mobile station devices 110 while avoiding an unallocatable resource block count. The efficiency of frequency utilization increases as a result. At this time, as illustrated in FIG. 11, it is possible to avoid creation of an unoccupied RB in order to satisfy Formula (1) and the resulting decrease in the utilization efficiency of radio resources. That is, even if a constraint is placed on the number of DFT points, a decrease in the efficiency of frequency band utilization can be minimized.

In the second embodiment, as the resource block to add, among frequency bands that can be allocated, the RB adjustment unit 43 may select a resource block in order from the one with the greatest value of priority, or may perform the selection on the basis of such a condition that it is easy separate the signals of overlapping RBs. Further, the RB adjustment unit 43 may select such a resource block which, when added, reduces the number of divisions of the frequency band to be allocated. Reducing the number of divisions makes it possible to obtain effects such as improved peak to average power ratio (PAPR) of the transmit signal and reduced out-of-band emission.

### Third Embodiment

Hereinafter, a third embodiment of the present invention will be described with reference to the figures. The third embodiment is directed to a case where Clustered DFT-S-OFDMA with a constraint on the number of divisions (the number of clusters) is used for the uplink. The third embodiment is directed to a case where the number of divisions is two.

Since the wireless communication system 100, the mobile station device 110, and the base station device 120 according to the second embodiment are configured in the same manner as in FIGS. 1, 2, 3, and 4, a description of their configuration will be omitted. However, the third embodiment differs from the first and second embodiments in the operation of the resource determination unit 42 of the base station device 120. In the third embodiment, when allocating a frequency band, the resource determination unit 42 is configured to satisfy Condition A′ instead of Condition A mentioned above. Condition A′ requires that it be permitted to divide the group of frequency bands allocated to the mobile station device 110 up to two subgroups.

FIG. 12 illustrates an example of the result of allocation by the resource determination unit 42 according to the third embodiment. In FIG. 12, the horizontal axis represents frequency. Further, symbols RB1, RB2, . . . and RB15 each denote a resource block. In the example illustrated in FIG. 12, the resource determination unit 42 allocates a frequency band (resource blocks RB1 to RB4, and RB9 to RB12) denoted by symbol B21 to the first mobile station device 110. Further, the resource determination unit 42 allocates a frequency band (resource blocks RB5 to RB8, and RB13 to RB15) denoted by symbol B22 to the second mobile station device 110. Because the frequency band B21 is made up of eight resource blocks, the corresponding number of DFT points is 8×12=96. The prime factors of 96 are only 2 and 3, and hence Formula (1) is satisfied. Because the frequency band B22 is made up of seven resource blocks, the corresponding number of DFT points is 7×12=84. The prime factors of 84 are 2, 3, and 7, and hence Formula (1) is not satisfied.

FIG. 13 illustrates an example of the result of allocation by the scheduler 27 according to the third embodiment. In FIG. 13, the horizontal axis represents frequency. The allocation result illustrated in FIG. 13 is an example of the result of allocation by the scheduler 27 when the allocation illustrated in FIG. 12 has been executed by the resource determination unit 42. Because the frequency band B22 illustrated in FIG. 12 does not satisfy Formula (1), the RB adjustment unit 43 adds some one resource block to the frequency band B22. At this time, the resource block(s) to add is one that is adjacent to either end of a group of already-allocated resource blocks. Accordingly, in the case of FIG. 12, RBs that can be added are {RB4, RB9, and RB12}. These RBs are defined as allocatable RBs. From among these allocatable RBs, the RB adjustment unit 43 selects and adds an RB with the highest priority. Specifically, letting S be a set of allocatable RBs, and u′ be the index of a mobile station device with an unallocatable resource block count, the RB to be allocated is determined by the formula below.

$$\begin{matrix}[ Formula 3 ] & \\ m = arg {max}_{{m}^{′} ∈ S} P ( {u}^{′} , {m}^{′} ) & ( 3 )\end{matrix}$$

The RB with an index m determined by Formula (3) is allocated to the u′-th mobile station device 110. In the case of the first embodiment, the RB included in the set S is RB8 in the first mobile station device 110, and in the case of the second embodiment, all RBs are included in the set because the number of clusters is infinite.

Further, in a case where increasing the number of RBs by 1 in Formula (3) still results in a frequency index indicating an unallocatable RB count (for example, in a case where the resulting RB count is 14 RBs), the set S is defined again with the RB increased by Formula (3) as an allocation resource, the number of allocated resources is further increased by Formula (3), and this process is repeated until the resulting resource block count becomes one that is not unallocatable. In this way, any situation can be handled.

A frequency band B22′ obtained by adding the resource block RB12 in this way is determined as the result of allocation to the second mobile station device 110 by the scheduler 27. Because the frequency band B22′ is made up of eight resource blocks, the corresponding number of DFT points is 8×12=96, and hence Formula (1) is satisfied. At this time, since the frequency band B21 illustrated in FIG. 12 satisfies Formula (1), the mobile station device selection unit 44 determines the frequency band B21, which is obtained as a result of allocation by the resource determination unit 42, as the result of allocation to the first mobile station device 110 by the scheduler 27 as it is.

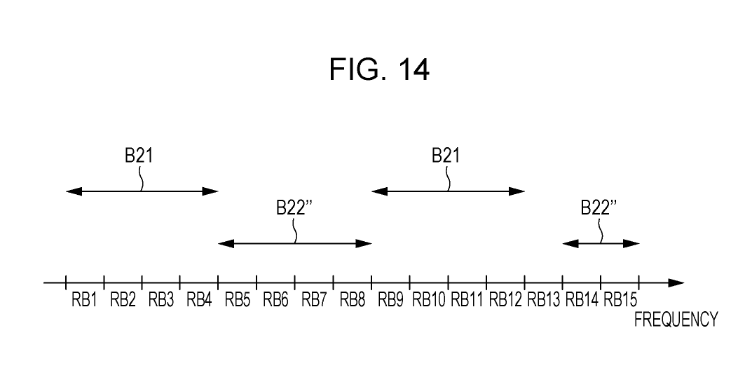

FIG. 14 illustrates an example of the result of conventional allocation. The example illustrated in FIG. 14 represents the result of conventional allocation executed in the same situation as when the resource determination unit 42 has performed allocation as illustrated in FIG. 12. In conventional methods such as NPL 1, allocation is performed so as to satisfy Formula (1), in addition to Conditions A′ and B mentioned above. Accordingly, while the first mobile station device is allocated the frequency band B21 as in FIG. 12, the second mobile station device is allocated a frequency band B22″ that is obtained by removing the resource block B13 from the frequency band B22 and thus made up of resource blocks RB4 to RB6, and RB14 and RB15.

In this way, even in the case of Clustered DFT-S-OFDM with a constraint on the number of divisions, resource blocks that should be allocated can be used by each of the mobile station devices 110 while avoiding an unallocatable resource block count. That is, even if a constraint is placed on the number of DFT points, a decrease in the efficiency of frequency band utilization can be minimized. Further, this is equivalent to allocating more radio resources for some RBs, which also contributes to higher utilization efficiency of radio resources.

The mobile station device 110 and the base station device 120 may be implemented by recording a program for realizing some or all of the functions of the mobile station device 110 and base station device 120 in each of the embodiments mentioned above to a computer-readable recording medium, and causing a computer system to read and execute the program recorded on this recording medium. The term “computer system” as used herein includes OS and hardware such as peripheral devices.

The term “computer-readable recording medium” as used herein refers to a portable medium such as a flexible disk, a magneto-optical disk, a ROM, or a CD-ROM, or a storage device such as a hard disk embedded in a computer system. Further, the term “computer-readable recording medium” as used herein also includes one that dynamically holds a program for a short period of time, like a communication line used when transmitting a program via a network such as the Internet or a communication circuit such as a telephone circuit, and one that holds a program for a predetermined period of time, like a non-volatile memory within the computer system which serves as a server or a client in that case. The above-mentioned program may be a program for implementing some of the functions mentioned above, or may further be a program that can implement the above-mentioned functions in combination with a program already recoded on the computer system.

Each of the mobile station device 110 and the base station device 120 in the above-mentioned embodiments may, in part or in whole, be implemented typically in an LSI that is an integrated circuit. The functional blocks of the mobile station device 110 and base station device 120 may each be individually integrated into a chip, or some or all of the functional blocks may be integrated into a chip. The technique for circuit integration is not limited to LSI but an implementation using a dedicated circuit or a general-purpose processor is also possible. If a circuit integration technology that serves as an alternative to LSI emerges with advances in semiconductor technology, it is also possible to use an integrated circuit based on such a technology.

While embodiments of the present invention have been described above in detail with reference to the figures, the specific configuration of the present invention is not limited to these embodiments but the present invention is intended to embrace all such design variations that do not depart from the scope of the present invention.

### INDUSTRIAL APPLICABILITY

The present invention is suitable for use in, but not limited to, mobile communication systems in which cellular phone devices serve as mobile station devices.

### REFERENCE SIGNS LIST

1 encoder
2 modulator
3 DFT unit
4 resource allocator
5 demodulation reference signal multiplexer
6 IFFT unit
7 switching unit
8 sounding reference signal multiplexer
9 CP insertion unit
10 transmitter
11 transmit antenna
12 receiver
13 control information detector
14 MCS identification unit
15 resource identification unit
16 demodulation reference signal generator
17 sounding reference signal generator
18 receive antenna
21 receive antenna
22 receiver
23 CP removal unit
24 switching unit
25 sounding reference signal separator
26 channel sounding unit
27 scheduler
28 control signal generator
29 transmitter
30 FFT unit
31 demodulation reference signal separator
32 channel estimator
33 resource separator
34 signal detector
35 transmit antenna
41 priority calculator
42 resource determination unit
43 RB adjustment unit
44 mobile station device selection unit
100 wireless communication system
110 mobile station device
120 base station device

1. A base station device comprising:
an allocation determination unit configured to allocate a frequency band of subcarriers to each of a plurality of communication devices that applies an orthogonal transform to a signal to be transmitted and transmits the signal by arranging the signal on the subcarriers;
a communication device selection unit configured to select, from among the plurality of communication devices, a communication device for which a number of subcarriers included in the frequency band allocated to the communication device by the allocation determination unit is not a prescribed number; and
a frequency band adjustment unit configured to perform a change that changes a frequency band allocated to the selected communication device, from the frequency band allocated by the allocation determination unit,
wherein the frequency band adjustment unit performs the change in such a way that a number of subcarriers included in a frequency band obtained as a result of the change becomes the prescribed number.

2. The base station device according to claim 1, wherein:
the allocation determination unit allocates the frequency band in such a way that there is no overlap of allocated frequency bands between the plurality of communication devices; and
the frequency band adjustment unit performs the change by permitting an overlap of allocated frequency bands between the selected communication device and another communication device, and performing an addition of a frequency band to the frequency band allocated by the allocation determination unit.

3. The base station device according to claim 2, wherein in a case of performing the addition of a frequency band, the frequency band adjustment unit performs the addition in order from a frequency band with high priority, among frequency bands that can be allocated.

4. The base station device according to claim 2, wherein the frequency band to be added by the frequency band adjustment unit is a frequency band that is adjacent to the frequency band allocated by the allocation determination unit.

5. The base station device according to claim 2, comprising:
a receiver configured to receive signals transmitted by the plurality of communication devices; and
a signal detector configured to detect a signal of each of the communication devices from the received signals,
wherein for a signal of the communication device for which the allocated frequency band overlaps another communication device, the signal detector performs interference cancellation to separate the signal from the received signals.

6. The base station device according to claim 5, wherein the interference cancellation is a non-linear iterative equalization based on a turbo principle or serial interference cancellation.

7. The base station device according to claim 1, wherein the orthogonal transform is a time-frequency transform.

8-9. (canceled)

10. A frequency band allocation method for a base station device, comprising:
a first step of allocating a frequency band of subcarriers to each of a plurality of communication devices that applies an orthogonal transform to a signal to be transmitted and transmits the signal by arranging the signal on the subcarriers;
a second step of selecting, from among the plurality of communication devices, a communication device for which a number of subcarriers included in the frequency band allocated to the communication device in the first step is not a prescribed number; and
a third step of performing a change that changes a frequency band allocated to the selected communication device, from the frequency band allocated by the first step,
wherein the third step includes performing the change in such a way that a number of subcarriers included in a frequency band obtained as a result of the change becomes the prescribed number.

11. (canceled)

12. A program for causing a computer of a base station device to function as:
an allocation determination unit configured to allocate a frequency band of subcarriers to each of a plurality of communication devices that applies an orthogonal transform to a signal to be transmitted and transmits the signal by arranging the signal on the subcarriers;
a communication device selection unit configured to select, from among the plurality of communication devices, a communication device for which a number of subcarriers included in the frequency band allocated to the communication device by the allocation determination unit is not a prescribed number; and
a frequency band adjustment unit configured to perform a change that changes a frequency band allocated to the selected communication device, from the frequency band allocated by the allocation determination unit,
wherein the frequency band adjustment unit performs the change in such a way that a number of subcarriers included in a frequency band obtained as a result of the change becomes the prescribed number.

13. (canceled)
